(19) United States
(12) Patent Application Publication
(10) Pub. No.: US 2005/0030253 A1
(43) Pub. Date: Feb. 10, 2005

(54) Dual-screen notebook computer

(75) Inventor: Ying-Ta Lu, Taipei (TW)

Correspondence Address: BROWDY AND NEIMARK, P.L.L.C.;624 NINTH STREET, NW, SUITE 300, WASHINGTON, DC, 20001-5303, US

(73) Assignee: FIRST INTERNATIONAL COMPUTER INC, Taipei (TW)

(21) Appl. No.: 10/632,909

(22) Filed: Aug. 4, 2003

(51) Int. Cl. G09G 5/00

(52) U.S. Cl. 345/1.1

(57) ABSTRACT

A dual-screen notebook computer is disclosed and has a notebook computer with an LCD display module, a pivot structure provided at one side of the notebook computer, and a supplementary display module fastened pivotally with the pivot structure and electrically connected to an internal control circuit of the notebook computer for output of current status information of the notebook computer.

### BACKGROUND OF THE INVENTION

1. Field of the Invention

The present invention relates to a notebook computer and, more particularly, to a dual-screen notebook computer, which has a supplementary display module fastened pivotally with one side of the main LCD display module for output of current status information of the notebook computer.

2. Description of the Related Art

Following fast development of computer technology, the notebook computer has become more and more popular. A regular notebook computer has an LCD display module for data output. In order to meet consumers' requirements and enhance market competitiveness, various notebook computers with added functions are developed.

Further, when traveling, one may carry a digital video camera to pick up visual images, or a game boy for playing video games. However, a digital video camera does not provide editing and data transmission functions.

Therefore, it is desirable to provide a notebook computer that has a digital video camera and a game boy incorporated therein.

### SUMMARY OF THE INVENTION

The present invention has been accomplished under the circumstances in view. It is the main object of the present invention to provide a notebook computer, which has a digital video camera and a game boy control incorporated therein. It is another object of the present invention to provide a notebook computer, which provides added functions to enhance its market competitiveness. It is still another object of the present invention to provide a notebook computer, which provides a supplementary display module enabling the user to check the current status information of the notebook computer without opening the notebook computer. According to one aspect of the present invention, the dual-screen notebook computer comprises a notebook computer with an LCD display module, a pivot structure provided at one side of the notebook computer, and a supplementary display module fastened pivotally with the pivot structure and electrically connected to an internal control circuit of the notebook computer for output of current status information of the notebook computer. According to another aspect of the present invention, a digital video camera is installed in the notebook computer. According to still another aspect of the present invention, a game body control button module is installed in the notebook computer for controlling the operation of a game boy.

### BRIEF DESCRIPTION OF THE DRAWINGS

FIG. 1 is an elevational view of a dual-screen notebook computer according to the present invention;

FIG. 2 is an exploded view of the dual-screen notebook computer according to the present invention;

FIG. 3 illustrates the notebook computer opened, the supplementary LCD display module turned out of the notebook computer;

FIG. 4 illustrates one application example of the dual-screen notebook computer according to the present invention; and

FIG. 5 is an elevational view of an alternate form of the dual-screen notebook computer according to the present invention.

### DETAILED DESCRIPTION OF THE PREFERRED EMBODIMENT

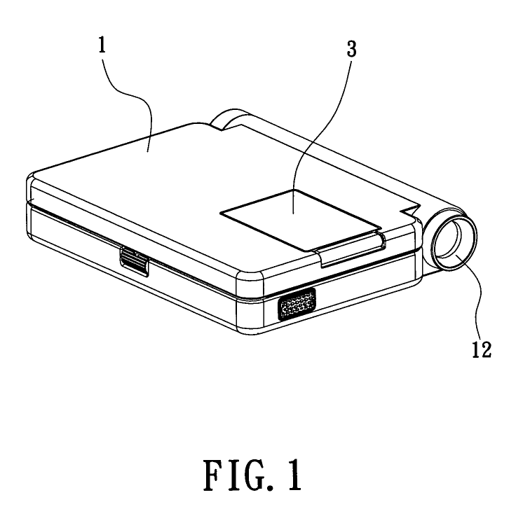

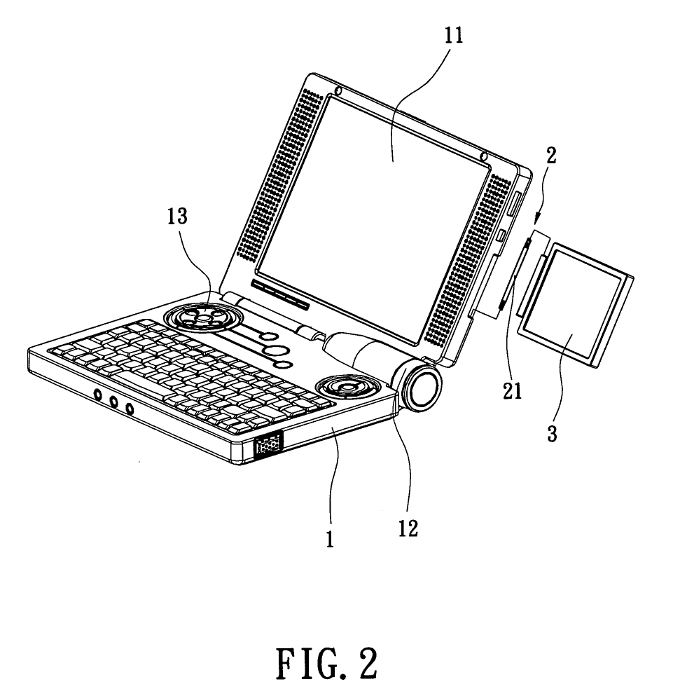

Referring to FIGS. 1-3, a dual-screen notebook computer is shown and comprises a notebook computer 1, a pivot structure 2, and a supplementary display module 3. The notebook computer 1 comprises a main LCD display module 11, a digital video camera 12, and a game body control button module 13. The pivot structure 2 is provided at one side of the notebook computer 1, for example, at the right side of the main LCD display module 11. The supplementary display module 3 is coupled to the pivot structure 2 and electrically connected to the internal control circuit of the notebook computer 1 for output of current status information of the notebook computer 1. The aforesaid pivot structure 2 comprises a pivot shaft 21 fastened pivotally with the right side of the main LCD display module 11 of the notebook computer 1. The supplementary LCD display module 3 is pivotally coupled to the pivot shaft 21 of the pivot structure 2.

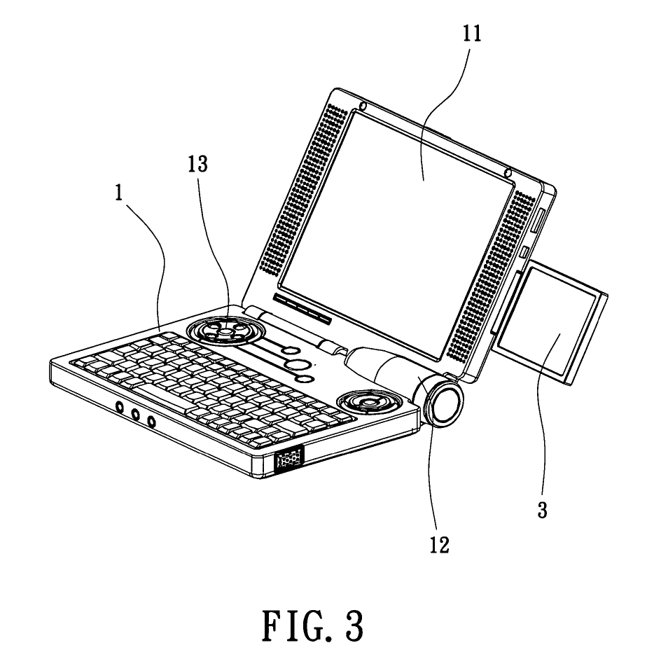

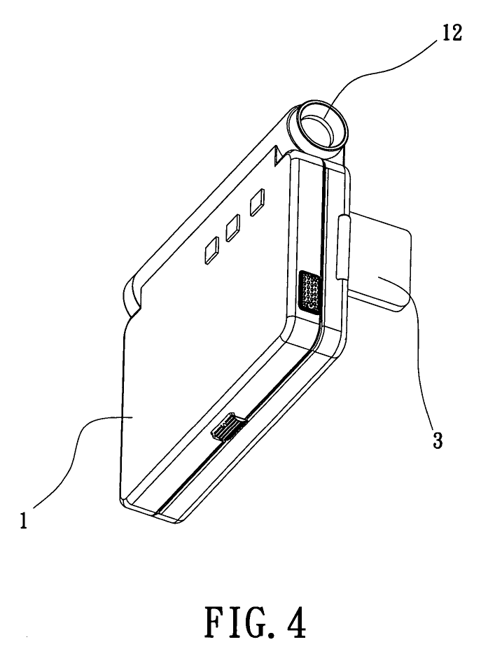

Referring to FIGS. 3 and 4 and FIG. 1 again, when not in use, the supplementary LCD display module 3 is turned about the pivot shaft 21 and closely attached to the back wall of the main LCD display module 11 of the notebook computer 1 in a flush manner with the display screen kept from sight (see FIG. 1). When in use (for example, when operating the digital video camera 12 to pick up visual images), the supplementary LCD display module 3 is turned about the pivot shaft 21 to the desired angle to display the visual images of the field (see FIGS. 3 and 4).

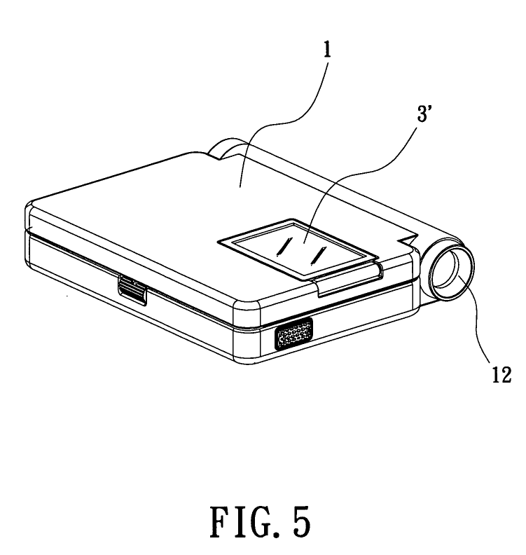

FIG. 5 shows an alternate form of the present invention. This embodiment is similar to the embodiment shown in FIGS. 1-4 with the exception of the reversed positioning of the supplementary LCD display module 3.

As indicated above, the design of the present invention has numerous advantages as follows:

1. A digital video camera is incorporated into the notebook computer. Through the notebook computer, the user can edit photographed visual images, and transmit edited video data to a remote site through the Internet wirelessly or through a local area network.

2. A game body is incorporated into the notebook computer for playing video games when traveling.

3. Through the supplementary LCD display module, the user can check the operation status of the notebook computer without opening the notebook computer.

4. The attached game boy, digital video camera and supplementary LCD display module give added functions to the notebook computer, enhancing the market competitiveness thereof.

A prototype of dual-screen notebook computer has been constructed with the features of FIGS. 1-5. The dual-screen notebook computer functions smoothly to provide all of the features discussed earlier.

Although particular embodiments of the invention have been described in detail for purposes of illustration, various modifications and enhancements may be made without departing from the spirit and scope of the invention. Accordingly, the invention is not to be limited except as by the appended claims.

1. A dual-screen notebook computer comprising:
a notebook computer, said notebook computer having an LCD display module;
a pivot structure provided at one side of said notebook computer; and
a supplementary display module fastened pivotally with said pivot structure and electrically connected to an internal control circuit of said notebook computer for output of current status information of said notebook computer.

2. The dual-screen notebook computer as claimed in claim 1, further comprising a game boy control button module installed in said notebook computer for controlling operation of a game boy.

3. The dual-screen notebook computer as claimed in claim 1, further comprising a digital video camera installed in said notebook computer.
